(19) United States
(12) Patent Application Publication
(10) Pub. No.: US 2022/0008289 A1
(43) Pub. Date: Jan. 13, 2022

(54) PILL CAPSULE HOLDING DEVICE FOR IMPROVED HANDLING OF SPRINKLE, POWDER, AND GRANULES MEDICATION

(71) Applicant: Tiffany Rowan, Sayville, NY (US)

(72) Inventor: Tiffany Rowan, Sayville, NY (US)

(21) Appl. No.: 17/371,413

(22) Filed: Jul. 9, 2021

Related U.S. Application Data
(60) Provisional application No. 63/049,816, filed on Jul. 9, 2020.

(51) Int. Cl. A61J 1/03; A61J 7/00

(52) U.S. Cl. CPC A61J 1/03; A61J 7/0076

(57) ABSTRACT

A pill capsule holding and administering device embodies a base formed with top, bottom and side surfaces. The top surface is adapted with a plurality of varying-sized port openings dimensioned to receive and hold by friction fit corresponding varying-sized pill capsules inserted into the port openings. The user determines which port opening is optimal for receiving and holding a particular pill capsule, inserts the pill capsule into the optimal port opening with sufficient insertion force to compress the pill slightly and/or otherwise create a friction fit between the pill surface and an inner holding surface of the port opening sufficient to maintain the pill capsule therein. The user then removes a portion of the pill capsule not held by friction to render accessible the medication and manipulates the holding device to pour out or otherwise deliver the medication to be administered, minimizing loss.

### CROSS-REFERENCE TO RELATED APPLICATIONS

This application derives the benefit of the filing date of U.S. Provisional Patent Application No. 63/049,816, filed Jul. 9, 2020. The contents of the provisional application are incorporated by reference in this application.

### BACKGROUND OF THE INVENTION

### Technical Field

The present invention relates to an inventive pill capsule-holding device and method for ergonomically distributing a sprinkle, powder, or granules of a medicine provided in hard or soft capsules to facilitate efficient administration, preferably with little or no spillage and, therefore, accurate and complete delivery of the amount of medicine loaded into the capsules.

### SUMMARY OF THE INVENTION

The inventive pill capsule holding device assists persons administering medications that can be consumed as “sprinkles, powder, or granules.” “Medication” is used herein to cover any type of medication, food or vitamin supplements or active agents that can be administered in powder, liquid or granular form, which preferably are adapted for administration (e.g., medication delivery and consumption in pill or capsule form (at times referred to herein as “pill capsules.”) The pill capsules typically comprise two cylindrical shells: an inner capsule shell that holds the medication in powder, granular or liquid form, and a slightly larger outer capsule shell that surrounds and covers the inner capsule shell. The outer capsule shell is lifted or slid off and separated from the inner capsule shell, rendering the contents of the inner capsule shell, i.e., the medication accessible. The pill capsules may be hard-shelled capsules used to contain dry powdered ingredients or miniature pellets and granules.

Holding a pill capsule in hand, and separating the outer capsule shell from the inner capsule part can be tricky, often resulting in “spilling” or otherwise losing medication. Inaccurate or “less than” a scheduled or intended dosage (amount) is typically not helpful. The inventive pill capsule holding device avoids problems associated with physically handling and disassembling the pill capsules to access the medication therein (for example, spilling while handling), by providing ports for stably holding and handing different sized pill capsules. For example, a holding device includes a plurality of differing-diameter pill capsule holding ports, where a user inserts a pill capsule containing a “sprinkle, powder, or granule” medication into a capsule holding port with an opening that is closest in size (but slightly smaller) to the diameter of the pill capsule. The port openings of the pill capsule holding device hold and secure the inner capsule shell once inserted therein, allowing for removable therefrom of the outer capsule shell.

That is, with the pill capsule secured by friction fit in a holding port, the user can remove the outer capsule shell to access the medication therein. Once the outer capsule shell is removed, a free flow of sprinkle, powder, or granular medication out of the inner capsule shell can occur. For that matter, with the inner capsule shell securely held, the holding device (and the inner capsule shell held therein) may be tilted or turned to pour or otherwise administer the medicine according to the user's wishes. This ability to control the holding device to control administration of the medicine in a way where none is likely spilled (wasted or otherwise lost).

Preferably, the port openings are designed to be fractionally smaller than an outside diameter of the cylindrical body of the inner capsule shell, to effect the friction fit so the pill capsule (shell) part does not fall out or otherwise dislodge when tilted). Depending on capsule rigidity, the port opening should be between 0 and 2% less that the outside diameter of the inner capsule shell, and most preferably, the inside diameters of the, ports or openings are about 0.53% less than the outside diameters of the inner capsule shells or parts to be secure therein. As such, compelling the inner pill capsule shell into a corresponding device opening realizes a “friction fit” between the outer surface of the inner capsule part and the inside contacting surface of the pill holding port. With the inner pill capsule part secured within the pill capsule holding device, the consumer can safely remove the outer pill capsule part and begin to prepare a liquid or soft feed to make medication more appealing. Hence, the full amount of the dose is likely administered by release upon the inventive holding device.

### BRIEF DESCRIPTION OF THE DRAWING FIGURES

Further features and advantages of the invention will become apparent from the description of embodiments that follows, with reference to the attached figures, wherein:

FIG. 1 is a front perspective view of one embodiment of the pill capsule holding device of the invention;

FIG. 2A depicts one embodiment of a pill capsule that may be utilized by the inventive pill capsule holding device;

FIG. 2B depicts the pill capsule presented in FIG. 2A, where the outer capsule shell is separated from the inner capsule shell;

FIG. 3 is a top plan view of the pill capsule holding device of FIG. 1;

FIG. 4 is a long side plan view of the pill capsule holding device of FIG. 1, the view defined by the direction of the arrow A in FIG. 1;

FIG. 5 is a short side plan view of the pill capsule holding device of FIG. 1, the view defined by the direction of the arrow B in FIG. 1;

FIG. 6A depicts the inventive pill capsule holding device in which a pail capsule has been inserted in one of the capsule holding ports; and

FIG. 6B depicts the device of FIG. 3A wherein the outer capsule part has been separated from the inner capsule part fixed in the port as shown.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

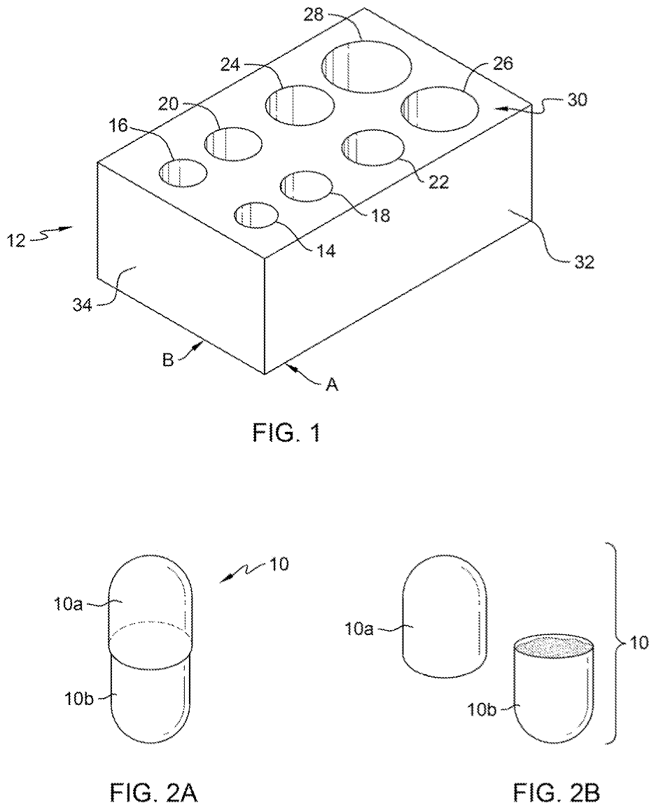

FIG. 1 presents a first embodiment of an inventive pill capsule holding device 12, constructed according to the inventive principles. The inventive pill capsule holding device 12 assists persons administering medicines formed to be consumed as “sprinkles, powder, or granules” provided for oral administration (delivery) in pill capsules 10. A pill capsule 10 is shown in FIGS. 2A and 2B as comprising an outer pill capsule shell or part 10a and an inner pill capsule shell or part 10b. The medicine material is arranged in the inner pill capsule shell 10b, where the outer pill capsule shell 10b is slightly larger than the inner pill capsule shell, and is slid over and onto the inner capsule shell (See FIG. 2A), “closing” the pill capsule 10 and its contents therein.

The pill capsule holding device 12 is constructed with a number of differing-sized pill capsule holding ports so that a number of possible different size pill capsules will likely have a corresponding holding port. For example, pill capsule holding ports 14, 16, 18, 20, 22, 24, 26, 28, as shown, each are defined by a respective port opening diameter that corresponds to the outside diameter of a respective inner capsule shell or part 10b. The diameters of the pill capsule holding port openings preferably are slightly less than or equal to the outside diameter of the surface of the inner pill capsule shells or parts 10b. The inside diameter of the holding ports 14, 16, 18, 20, 22, 23, 26 and 28 are between 0 and 2% smaller, and most preferably, 0.53% smaller than the outside diameters of the inner pill capsule shells to be seated (and secured) therein.

When the inner capsule shell 10b is forced into a respective port opening, the port opening acts to hold the slightly larger diameter shell, with or without the outer pill capsule shell, which is removable. Once a pill capsule 10, by its inner shell 10b is held in a correspondingly-sized holding port, the outer capsule shell 10a may be removed (separated) from the inner shell or part 10a, allowing access to any content therein. In an embodiment, it is preferable that the inner pill capsule shell 10a, which holds the medication, be somewhat compressible under pressure applied to insert the pill capsule into a port opening. It should be noted that while compressible is preferred, more rigids pill capsule shells merely require a larger insertion force than otherwise might be required with more flexible (compressible) capsules. Using the holding device to hold the pill capsule and medicine therein gives the user a certain amount of control over the administration of the medicine no available when opening and a pill capsule by hand, and trying to efficiently administer same, typically resulting in loss in the process.

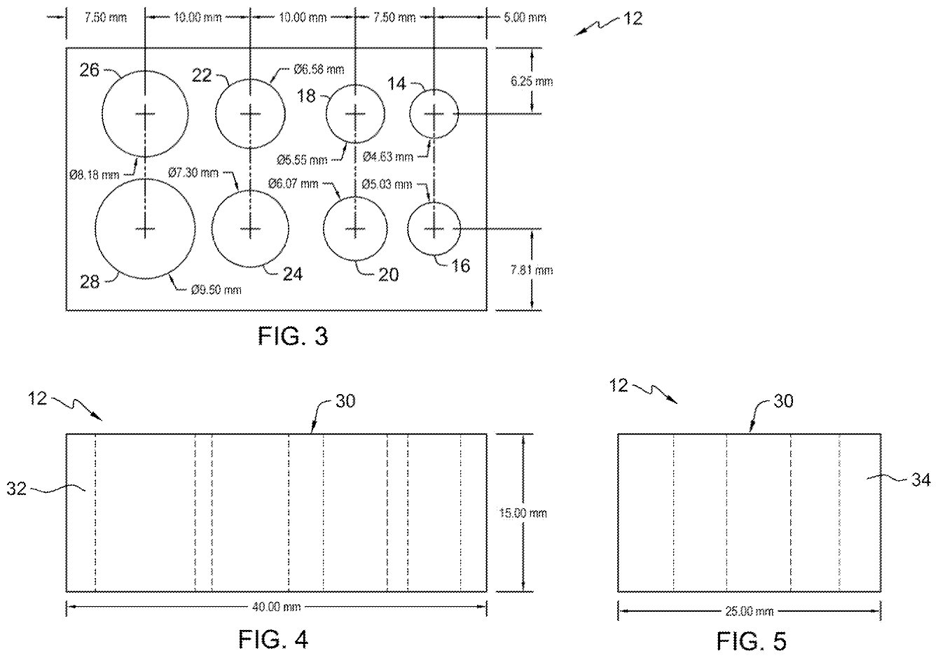

FIG. 3 presents a top plan view of the pill capsule holding device 12, to highlight the exemplary dimensions of the FIG. 1 embodiment. In this embodiment, each of openings 14, 16, 18, 20, 22, 24, 26 and 28 define port opening diameters that are equal to 4.63 mm, 5.03 mm, 5.55 mm, 6.07 mm, 6.53 mm, 7.30 mm, 8.18 mm and 9.50 mm, respectively. And as explained above, these varying inside diameters are to receive and hold (by friction fit) pill capsules 10 with pill capsule inner shells or parts 10b that are larger than the inside diameters of the corresponding port openings. Arrow A of FIG. 1 points to one of the opposing long sides 32 of the device 10 (see FIG. 4), where arrow B points to the short side 34 of the device (see FIG. 5). The embodiment is 40 mm in length, 25 mm in width and 15 mm in depth

While only eight (8) port openings 14, 16, 18, 20, 22, 24, 26 and 28 are shown in FIG. 1, the skilled artisan should readily understand that the inventive pill capsule holding device can accommodate any number of port openings. And the sizes of the openings are not limited to the exemplary sizes listed. For that matter, while the port openings are arranged at the top surface 30 of the device 10, the invention is not limited thereto. The inventive device 10 may have any number pill-holding port openings in any side; the invention is not limited to the top or any of the short and long sides 34, 32.

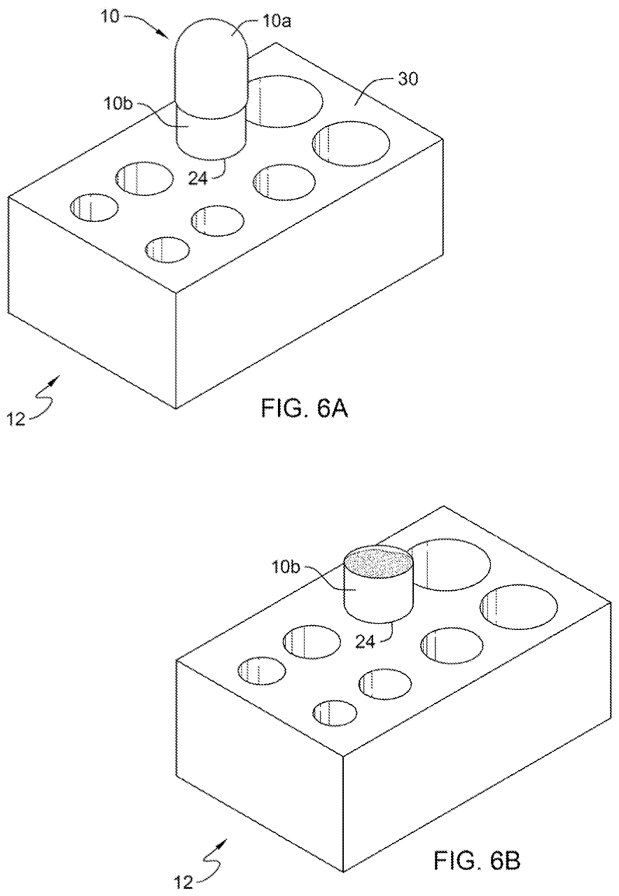

FIGS. 6A and 6b depict an embodiment where a pill capsule 10 is fixed by its inner capsule shell 10b in a holding port 24, which is about 7.30 mm in diameter. The pill capsule 10 preferably is 7.38 or 7.4 mm, so that being slightly larger than the port opening 24, it is forced in and held in by friction. FIG. 6B depicts the holding device 12 with the pill capsule outer shell 10a removed, such that only the pill capsule inner shell 10b is held in port 24.

The inventive pill capsule holding device 12 preferably is made of plastic, for example polyactic acid (PLA) or acrylonitrile butadiene styrene materials. But the holding device construction is not limited thereto, and also can be made of metals, for example, aluminum-based materials. The pill capsule holding device 12 functions as a sturdy base to be rested on a flat surface when not in use and still hold the capsule upright without losing any sprinkle, powder, or granule medication within it. Also, when being held, fingers rest upon the platform to reduce any slipping when gripping (and spillage resulting in inaccurate administration).

Preferably, numbers or other identifying indicia are located on the top surface 30, proximate the actual port openings (14, 16, 18, 20, 22, 24, 26 and 28), to indicate which size pill capsules the device holding ports are compatible with. But please note that while the holding device 10 embodiment shown in FIGS. 1 and 3-5 is dimensioned as 40×30 mm (and 15 mm high), and the port openings defined with specific diameters set forth in the figure (which are most preferably between 0 and 2% smaller that the outer diameter of the pill capsules intended to be held by friction therein), these dimensions are for exemplary purposes only. The particular dimensions are not meant to limit the scope or spirit of the invention as claimed. Preferably, the length and width is defined by a range of 10-100 mm, and 10-100 mm, respectively. Similarly, the diameters of the port openings are shown to be about 4.63 mm, 5.03 mm, 5.55 mm, 6.07 mm, 6.58 mm, 7.3 mm, 8.18 mm and 9.5 mm, respectively, these are preferred, where the diameters may range from 2 mm to 20 mm. Of course, as explained, the diameter of the pill capsules to be secured therein are slightly larger, from 0 to about 2% larger, and most preferably, 0.53% larger than the inside diameter of the port openings.

The invention also includes a method of using the pill capsule holding device 10. That is, a user wishing to conveniently and efficiently administer sprinkle, powder, and granules medication packaged in pill capsules, while avoiding spillage or other waste, finds the closest “fit” for his/her pill capsule in the holding ports. Once the best fit holding port is found, the user inserts the pill capsule therein. Depending of the flexibility of the inner shell, a certain amount of force is required to lodge and secure the shell therein. As explained above, the inside diameter of the port opening must be slightly smaller (0 to 2% smaller, most preferably, 0.53% smaller) that the outside diameter of the pill capsule inner shell or part 10b.

Then, the user removes the outer pill capsule shell from the inner pill capsule shell held fast in the port opening. The medicine therein should be readily accessible, and preferably flowable, once the covering (i.e., pill capsule, outer shell 10a) is removed. The user grasps then pill capsule holding device and turns or rotates it to pour out the medicine. The user may set down the device without consuming all pill capsule content, where same remaining content may be accessed at a later time. Conditions for spillage are minimized. The pill capsule holding device is readily cleaned, to remove pill capsule or medicine remnants.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A pill capsule holding and administering device, comprising:
a base formed with top, bottom and side surfaces;
wherein, the top surface is adapted with a plurality of varying-sized port openings that are dimensioned to receive and hold by friction fit corresponding varying-sized pill capsules, after the varying-sized pill capsules are inserted into respective varying-sized port openings.

2. The pill capsule holding and administering device of claim 1, wherein the varying-sized port openings grasp and hold pill capsules inserted therein to enable an outer part of the pill capsule to be removed while maintaining an inner part of the pill capsule and medicine to be administered therein, independent of device positioning.

3. The pill capsule holding and administering device of claim I, wherein the top and bottom surfaces are planar, and oppositely disposed, and the bottom surface allows the device to be stably seated on a supporting surface.

4. The pill capsule holding and administering device of claim 1, wherein the side surfaces are arranged to be readily graspable.

5. The pill capsule holding and administering device of claim 1, wherein an outside diameter or a pill capsule, or a part of a pill capsule to be held and secured in a pill capsule port opening in the top surface is greater than or equal to an inside diameter of a respective port opening adapted to receive and hold the pill capsule, or the part of the pill capsule.

6. The pill capsule holding and administering device of claim 1, wherein at least, one further port opening for receiving pill capsules is included in the sides.

7. The pill capsule holding and administering device of claim 1, wherein the port openings are formed with depths that accommodate at least 35% of a cylindrical height of a pill capsule intended to be received and held therein.

8. A method of administering medication provided in pill capsule form, in reliance upon a pill capsule holding and administering device formed with a top, bottom and side surfaces, the top surface adapted with a plurality of varying-sized port openings that are dimensioned to receive and hold by friction fit corresponding varying-sized pill capsules after insertion into the port openings, the method comprising the steps of:
determining which port opening of the pill capsule holding and administering device is optimal for receiving and holding a particularly-sized pill capsule loaded with medicine to be administered;
inserting the particularly-sized pill capsule into the optimal port opening with sufficient insertion force to compress the pill device slightly and rely upon a friction fit between a pill surface contacting an inner holding surface of the port opening sufficient to maintain the pill capsule therein;
removing a portion of the pill capsule that is not held by the friction fit to render accessible the medicine to be delivered; and
with the portion of the pill capsule containing the medicine to be administered is secured in the port opening, maneuvering the pill capsule holding and administering device to pour out or otherwise administer the medicine therein.

9. The method of administering medication of claim 8, wherein the pill capsules are formed with respective inner and outer shells, wherein the medicine to be administered is arranged in the inner shell, and wherein the outer shell is removed in the step of removing.

10. The method of administering medication of claim 9, wherein the medicine to be administered is arranged is in powder or granular form.

11. The method of administering medication of claim 8, wherein the pill capsules are soft capsules, the medicine to be administered is arranged in liquid form and the step of removing includes removing part of the soft capsule to render accessible the liquid medication.

12. The method of administering medication of claim 8, wherein an outside diameter of a pill capsule, or a part of a pill capsule to be held and secured in a pill capsule port opening in the top surface is greater than or equal to an inside diameter of a respective port opening adapted to receive and hold the pill capsule.
